(19) United States
(12) Patent Application Publication
(10) Pub. No.: US 2025/0340714 A1
(43) Pub. Date: Nov. 6, 2025

(54) THERMAL STABLE PPTC MATERIAL AND MANUFACTURING METHOD THEREOF

(71) Applicant: Dongguan Littelfuse Electronics Company Limited, Dongguan City (CN)

(72) Inventors: Jianhua Chen, Sunnyvale, CA (US); Flory Zhou, Shanghai (CN); Wei Zheng, Shanghai (CN)

(73) Assignee: Dongguan Littelfuse Electronics Company Limited, Dongguan City, GD (CN)

(21) Appl. No.: 19/128,222

(22) PCT Filed: Nov. 10, 2023
(86) PCT No.: PCT/CN2023/130897

§ 371 Date: May 8, 2025

(30) Foreign Application Priority Data
Nov. 10, 2022 (CN) 202211405297.0

(51) Int. Cl. C08K 3/04; C08K 9/00; C09C 1/56

(52) U.S. Cl. CPC C08K 3/04; C08K 9/00; C09C 1/565; C01P 2006/40; C08K 2201/001; C08K 2201/005; C08K 2201/011

(57) ABSTRACT

A high stability polymer positive temperature coefficient (PPTC) material. The high stability PPTC material may include a polymer matrix, the polymer matrix defining a PPTC body, and a conductive filler component, disposed in the polymer matrix. The conductive filler component may include a plurality of carbon black particles, wherein the plurality of carbon black particles comprises an average particle size of 50 nm or less, and wherein the plurality of carbon black particles comprise a treated surface.

### BACKGROUND

### Field

Embodiments relate to the field of circuit protection devices, including PTC devices.

### Discussion of Related Art

Positive temperature coefficient (PTC) devices may be used as overcurrent or over-temperature protection device, as well as current or temperature sensors, among various applications. For polymer positive temperature coefficient (PPTC) materials, these materials are generally arranged as a polymer matrix that contains a conductive filler, dispersed within the polymer matrix. The conductive filler generally occupies a sufficient volume fraction of the PPTC material so as to form continuous electrically conductive pathways that impart a relatively lower resistance. At a given temperature, often called the trip temperature, the expansion of the polymer matrix is sufficient to disrupt the continuous electrically conductive pathways so that resistance of the PPTC material may abruptly increase by tenfold, one hundredfold, one thousand fold, and so forth. Moreover, for polymer positive temperature coefficient (PPTC) materials operating even in a normal temperature range, below the trip temperature, a resistance change may take place when an environmental temperature change occurs, such as an increase in temperature. This resistance change will occur due to the thermal expansion or contraction (in the case of a decrease in temperature) of the polymer matrix that affects the electrical connection of the conductive filler dispersed in the polymer matrix, as discussed above. This resistance change may be especially pronounced for high resistivity (10˜10000 Ohm-cm) PPTC materials with low conductive filler content. The resistance variance in such environments will affect the resistance stability and constrain the application temperature range of such PPTC materials.

With respect to this and other considerations the present disclosure is provided.

### BRIEF SUMMARY (TO BE COMPLETED AFTER CLAIMS FINALIZED)

In one embodiment, a high stability polymer positive temperature coefficient (PPTC) material is provided. The high stability PPTC material may include a polymer matrix, the polymer matrix defining a PPTC body, and a conductive filler component, disposed in the polymer matrix. The conductive filler component may include a plurality of carbon black particles, wherein the plurality of carbon black particles comprises an average particle size of 50 nm or less, and wherein the plurality of carbon black particles comprise a treated surface.

In another embodiment, a method of preparing a high stability polymer positive temperature coefficient (PPTC) material is provided. The method may include providing a polymer material for a polymer matrix, providing a carbon black material as a conductive filler component, wherein the conductive filler component comprises a plurality of carbon black particles, and wherein the plurality of carbon black particles comprises an average particle size of 50 nm or less. The method may further include mixing the carbon black material in the polymer matrix, wherein the plurality of carbon black particles comprises a treated surface before the mixing.

In a further embodiment, a high stability, high resistance polymer positive temperature coefficient (PPTC) material is provided. The high stability, high resistance polymer PPTC material may include a polymer matrix, the polymer matrix defining a PPTC body, and a conductive filler component, disposed in the polymer matrix, wherein the conductive filler component comprises a plurality of carbon black particles. As such, the plurality of carbon black particles may have an average particle size of 50 nm or less, and the plurality of carbon black particles may have a treated surface.

### BRIEF DESCRIPTION OF THE DRAWINGS

FIG. 1A, FIG. 1B, and FIG. 1C depict different views of a novel conductive filler, in accordance with embodiments of the disclosure;

FIG. 2A shows a cross-sectional depiction of a PPTC device arranged according to the present embodiments, at relatively lower temperature;

FIG. 2B shows a cross-sectional depiction of the PPTC device of FIG. 2A at a relatively higher temperature;

FIG. 2C depicts a cross-section of a known PPTC material at a relatively lower temperature;

FIG. 2D shows a cross-sectional depiction of the PPTC material of FIG. 2C at a relatively higher temperature;

FIG. 3 shows a graph that depicts normalized resistance as a function of temperature for various different PPTC materials;

FIG. 4 shows a graph illustrating the resistance ratio as a function of resistivity for different PPTC materials;

FIG. 5 shows in histogram format a comparison of relative change is resistivity of PPTC samples after thermal cycling between −40° C. and 125° C.; and

FIG. 6 depicts an exemplary process flow.

### DESCRIPTION OF EMBODIMENTS

The present embodiments will now be described more fully hereinafter with reference to the accompanying drawings, in which exemplary embodiments are shown. The embodiments are not to be construed as limited to the embodiments set forth herein. Rather, these embodiments are provided so that this disclosure will be thorough and complete, and will fully convey their scope to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with one another. Also, the term “on,”, “overlying,” “disposed on,” and “over”, may mean that two or more elements are not in direct contact with one another. For example, “over” may mean that one element is above another element while not contacting one another and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In various embodiments, novel PPTC materials are provided for forming a PPTC device, where the PPTC device is configured to operate with a relatively more stable resistance in the normal operating temperature range, below the trip temperature. The present embodiments may employ a novel conductive filler including an assembly or plurality of carbon black particles having a reduced particle size an special surface treatment. As a result, the novel conductive filler may exhibit a superior dispersion within a polymer matrix, leading to an improved resistance distribution and resistance stability.

A high stability polymer positive temperature coefficient (PPTC) material is provided. The term ‘high stability’ may refer to a relatively lesser resistance change within a PPTC material when cycled up and down through a given temperature range, relatively lesser overall change in resistance when PPTC temperature is increased from room temperature to a given threshold temperature, such as 125° C., relatively lower distribution of resistance values for nominally the same material, or any combination of these factors.

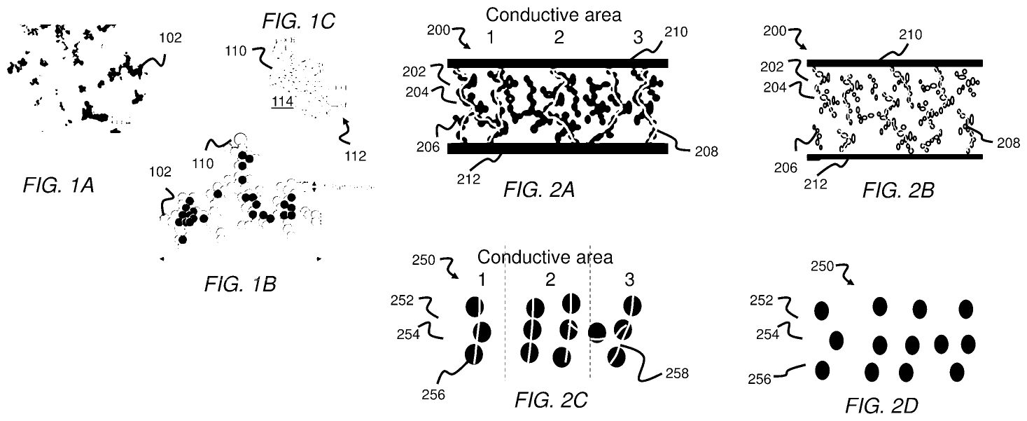

FIG. 1A, FIG. 1B, and FIG. 1C depict different views of a novel conductive filler, in accordance with embodiments of the disclosure. In FIG. 1A there is shown an example of a dispersion of conductive filler 102. The view may represent a microscopic image of a plurality of carbon black particles, having a particle size on the order of a few tens of nanometers. As illustrated, the carbon black particles may be isolated as single particles, but may tend to agglomerate in groups, comprising a plurality of particles, ranging from just a few to tens, hundreds, or thousands. In various embodiments of PPTC materials, when dispersed in a polymer matrix carbon black particles may agglomerate in chains or chain-like configurations, that may form networks of continuously electrically conductive paths that may span macroscopic distances, such as millimeters or more. These paths or chains are especially suitable for use in PPTC devices having opposing electrodes, separated by several millimeters or more. In various non-limiting embodiments, the polymer matrix that contains the carbon black particles may be formed of polyethylene and its copolymers, ethylene-vinyl acetate, ethylene and acrylic acid copolymer, ethylene butyl acrylate copolymer, polyolefin elastomer, polyethylene oxide, a fluororesin, polyvinyl fluoride, polydivinyl fluoride, polytetrafluoroethylene, ethylene-tetrafluoroethylene copolymer, polycaprolactone, polyethylene glycol, polytetrahydrofuran, polyurethane, a polyamide, copolymer of polyamide, a diene elastomer, a copolymer of diene elastomer, or combination thereof. In addition, the polymer matrix may also include an inorganic filler, a flame retardant agent, an antioxidant, a coupling agent, an arc suppressant, a cross-linker, or combination thereof. As depicted in FIG. 1B in particular, the conductive filler 102 will tend to organize at least in part by agglomeration of particles, where an individual particle of carbon black is shown as particle 110. According to various embodiments of the disclosure, the plurality of carbon black particles that form the conductive filler 102 comprise an average particle size of between 10 nm and 50 nm, and in particular embodiments comprise an average particle size of between 10 nm and 50 nm, and a dibutylpthalate (DBP) value 50 ml/100 g to 150 ml/100 g, and in particular embodiments between 50 ml/100 g to 90 ml/100 g.

Note that existing general use carbon black formulations have primary particle sizes in the range of 70 nm to 100 nm, yielding a dibutylpthalate (DBP) value of 70 ml/g to 100 ml/g, which measurement is an indication of surface area. So called low structure carbon black formulations may employ a particle size of between 60 nm to 150 nm, with a DBP number of less than 50 ml/100 g.

Because of the lower average particle size of carbon blacks used in the PPTC materials of the present embodiments, for a given volume fraction of conductive filler (carbon black in this case) there will be more carbon particles than in prior known PPTC materials. The greater number of particles may aid in the formation of more conductive chains and conductive pathways for a given total volume fraction of conductive filler. Moreover, according to the present embodiments, the carbon black particles may be subjected to one or more surface treatments, wherein a treated surface is formed on the carbon black particles. FIG. 1C provides a particular illustration of a treated surface 112 for a particle 110. The interior 114 of the particle 110 will tend to be predominantly carbon, while the treated surface 112 may have different chemical and physical characteristics compared to the carbon interior.

In some embodiments the treated surface 112 may be a high-temperature oxidized surface, meaning a surface of a carbon particle after being subjected to high temperature oxidation. In other embodiments, the treated surface 112 may be a grafted surface that includes heterogeneous (non-carbon) species that are bonded to the inner portion, interior 114. In particular embodiments, the treated surface 112 may represent a surface of a carbon black particle that is treated with a coupling agent. As an example, a surface treatment of carbon black particles with a suitable chemical formulation may be performed, followed by high temperature oxidation.

In some embodiments, the resultant surface, that is, treated surface 112, may exhibit a greater number of polar species or polar groups, such as those depicted in FIG. 1C. The presence of the greater number of polar groups may then lead to a greater dispersion of the carbon black conductive filler within a polymer matrix, and may aid in bonding to the polymer matrix. These qualities may then lead to improved resistance distribution and resistance stability as compared to known PPTC formulations.

Turning now to FIG. 2A there is shown a cross-sectional depiction of a PPTC device 200 arranged according to the present embodiments, at a first temperature, which temperature is a relatively lower temperature. In FIG. 2B there is shown a cross-sectional depiction of the PPTC device 200 at a second temperature, which temperature is a relatively higher temperature. The PPTC device 200 includes a PPTC body 202, formed of a polymer matrix 204 and a conductive filler 206, dispersed in the polymer matrix 204. In the illustration shown, an electrode 210 and electrode 212 are depicted to illustrate the general direction of current flow through the PPTC device 200 during operation. The conductive filler 206 may comprise the aforementioned carbon black particles that may agglomerate into chain-like configurations, as detailed in FIG. 1B, in particular. Because of the relatively small particle size, such as 18 nm to 30 nm, and the treated surface (as illustrated by treated surface 112, FIG. 1C), such as an oxidized and/or polar surface, the carbon black particles may have a relatively stronger interaction with the polymer matrix 204, such that the clusters or agglomerations of carbon black particles form more evenly dispersed chains.

Because in PPTC body 202 the relative number of carbon particles is much greater for a given volume fraction of carbon black as compared to known PPTC formulations having particles in the range of ˜70 nm, and because the dispersion is better, a greater number of conductive paths, shown as conductive paths 208, may be formed, as compared to a reference PPTC sample 250, shown in FIG. 2C. In FIG. 2C, the reference PPTC sample 250 includes a body 252 that contains a polymer matrix 254 and conductive filler 256, such as 70 nm carbon black particles. Because of the larger particle size, the number of conductive paths 258 may be fewer, as compared to the PPTC device 200, arranged according to the present embodiments. Considering any particular region, such as the labeled conductive areas 1, 2, 3, because of the relatively larger size of particles in PPTC sample 250, and thus a lower number density of carbon black particles, any small fluctuation in the number of particles may cause a large variation in resistance. In comparison, considering the PPTC device 200, a small variation in the number of particles in a given region, will not substantially change the resistance due to the much larger number density of particles for a given overall volume fraction of carbon black.

Moreover, when the PPTC device 200 is cycled between a lower temperature (FIG. 2A) and a higher temperature (FIG. 2B), the conductive paths 208 may be better preserved at a given temperature, as compared to the reference PPTC sample 250, where the conductive paths are more disrupted when the polymer matrix 254 expands, as shown in FIG. 2D. Furthermore, when cycled back and forth between a lower temperature (FIG. 2A) and a higher temperature (FIG. 2B), the conductive paths 208 may be better retained, such that the resistance is more stable, in addition to having a better resistance distribution.

This greater stability imparted to a conductive filler by virtue of the smaller carbon black particle size and the formation of treated surfaces may be especially useful for high resistivity PPTC materials. In various embodiments, a PPTC material may be formed with a conductive filler as described above with respect to FIGS. 1A-1C, and 2A-2B, where the volume fraction of the conductive filler, in particular, carbon black, is between 4% and 30%, and more particularly between 10% and 25%, where the resistivity may be relatively higher, such as 10 Ohm-cm or greater.

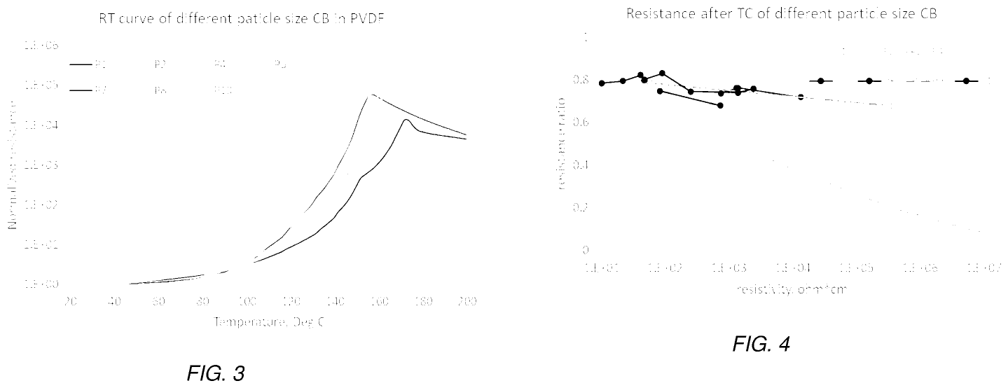

Turning to FIG. 3, there is shown a graph that depicts normalized resistance as a function of temperature for various different PPTC materials, where the diameter of carbon black particles, dispersed in a PVDF polymer matrix, is varied between the different PPTC materials. The CB particle size decreases with increasing ‘number” going from sample P1 to P10. Note that in terms of absolute resistivity, a higher particle size and lower DBP value require a higher carbon loading for the same resistivity. The surface treatment and compounding process will also affect the resistivity. For the sample P3, a very low structure carbon, the carbon loading is 35 vol % at a resistivity close to 1000 Ohm-cm. For samples, the carbon fraction is between 10˜20 vol % at a resistivity 1000 Ohm-cm.

Turning to FIG. 4, there is shown a graph illustrating the resistance ratio as a function of resistivity for different PPTC materials, where the CB particle size varies between different materials. In particular, the resistance ratio of FIG. 4 represents the ratio of (room temperature resistance of the sample after thermal cycling)/(room temperature resistance before thermal cycling). To determine this ratio, the initial resistance is firstly measured at room temperature, followed by placement of the samples in a test oven, dwell 30 min at each temperature, with change to the next temperature rapidly (test temperature is −40˜85 deg C., for 6 test cycles in total. Subsequently, the samples are removed, and the final resistance measured after 1 hr at room temperature, where the final resistance represents the numerator in the above equation for resistance ratio, and the initial resistance is the denominator.

As illustrated, for several of the samples the resistance ratio is relatively stable over a large resistivity range between 10 Ohm-cm and up to almost 106 Ohm-cm. Moreover, for these samples, the resistance ratio is relatively close to 1 (˜0.65-0.85), indicating better resistance stability. These materials with better stability correspond to samples P6-P10, with relatively smaller particle size. In particular, the particle size decreases from samples P1 to P5 from approximately 90 nm to 60 nm, and for samples P6 to P10 the particle size decrease from approximately 40 nm to 20 nm.

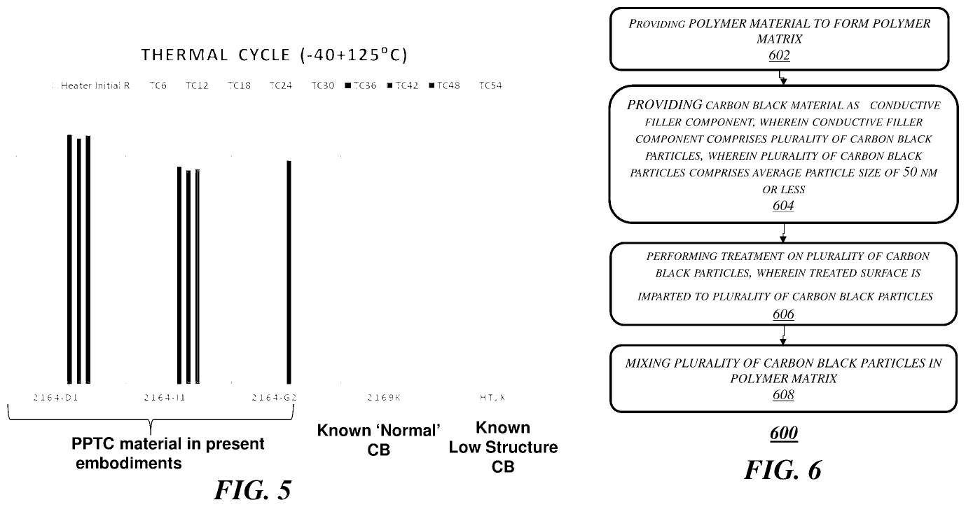

Turning to FIG. 5, there is shown in histogram format a comparison of relative change is resistivity of PPTC samples after thermal cycling between −40° C. and 125° C. There are three main blocks of data shown, one block for a known PPTC material having low structure carbon black filler (furthest right); one block for a known ‘normal’ PPTC material having relatively higher structure carbon black; and one block, divided into three sub-blocks, for three different PPTC material samples, prepared according to the present embodiments. In each set of samples, the furthest left histogram represents the initial sample before thermal cycling where the relative resistance, compared to the initial resistance, is 1.0 by definition. From left to right, within a given sample, the different histogram bars represent and increasing number of thermal cycles, up to 48 in some cases. The results illustrate that the samples arranged according to the present embodiments exhibit a high degree of stability, where relative resistivity decreases to no less than 0.94 or increases to no more than 1.09 depending upon PPTC sample and number of cycles. In contrast, the ‘normal’ PPTC material exhibits a steep decrease in relative resistivity to 0.81 after just 6 cycles and decreases further to 0.69 after just 12 cycles. Moreover, the low structure CB sample exhibits a steep decrease or essentially a resistivity collapse, to a relative resistivity of just 0.02 after 6 cycles.

FIG. 6 depicts an exemplary process flow 600, according to embodiments of the disclosure. At block 602, a polymer material is provided to form a polymer matrix for a PPTC material. In various non-limiting embodiments, the polymer matrix may be formed of polyethylene and its copolymer, ethylene-vinyl acetate, ethylene and acrylic acid copolymer, ethylene butyl acrylate copolymer, polyolefin elastomer, polyethylene oxide, polyvinyl fluoride, polydivinyl fluoride, polytetrafluoroethylene, ethylene-tetrafluoroethylene copolymer, polycaprolactone, polyethylene glycol, polytetrahydrofuran, polyurethane, a polyamide, copolymer of polyamide, a diene elastomer, a copolymer of diene elastomer, or combination thereof. In addition, the polymer matrix may also include an inorganic filler, a flame retardant agent, an antioxidant, a coupling agent, an arc suppressant, a cross-linker, or combination thereof.

At block 604, carbon black material is provided as a conductive filler component for forming the PPTC material, wherein the conductive filler component comprises a plurality of carbon black particles that have an average particle size of 50 nm or less. In some non-limiting embodiments, the average particle size may be 10 nm and 50 nm and more particularly between 18 nm and 30 nm.

At block 606 a treatment is performed on the plurality of carbon black particles, wherein a treated surface is imparted to the plurality of carbon black particles. In various embodiments, the treatment may involve subjecting the plurality of carbon black particles to a high-temperature oxidization treatment. In other embodiments, the treatment comprises bonding a heterogeneous chemical species to a surface of a carbon black particle. In further embodiments, the treatment comprises mixing a coupling agent to a surface of a carbon black particle. According to some embodiments, the treatment may be performed before the mixing of carbon black particles into a polymer matrix.

At block 608, the plurality of carbon black particles are mixed in the polymer matrix.

In some embodiments, the mixing may be performed so that the conductive filler component comprises a volume percentage ranging between 4% to 30%, and more particularly between 10% and 25%.

In summary, the PPTC materials of the present embodiments provide a more stable resistance behavior as compared to known PPTC materials, especially after thermal cycling, which stability is especially important for heater applications.

While the present embodiments have been disclosed with reference to certain embodiments, numerous modifications, alterations and changes to the described embodiments are possible while not departing from the sphere and scope of the present disclosure, as defined in the appended claims. Accordingly, the present embodiments are not to be limited to the described embodiments, and may have the full scope defined by the language of the following claims, and equivalents thereof.

What is claimed is:

1. A high stability polymer positive temperature coefficient (PPTC) material, comprising:
a polymer matrix, the polymer matrix defining a PPTC body; and
a conductive filler component, disposed in the polymer matrix,
wherein the conductive filler component comprises a plurality of carbon black particles, wherein the plurality of carbon black particles comprises an average particle size of 50 nm or less, and
wherein the plurality of carbon black particles comprise a treated surface.

2. The high stability PPTC material of claim 1, wherein the treated surface comprises a high-temperature oxidized surface.

3. The high stability PPTC material of claim 1, wherein the treated surface comprises a grafted surface that comprises a heterogeneous chemical species, bonded to an inner portion of a carbon black particle.

4. The high stability PPTC material of claim 1, wherein the plurality of carbon black particles comprise an average particle size of between 10 nm and 50 nm.

5. The high stability PPTC material of claim 1, wherein the plurality of carbon black particles comprise an average particle size of between 18 nm and 30 nm.

6. The high stability PPTC material of claim 1, wherein the conductive filler component comprises a volume percentage ranging between 4% to 30%.

7. The high stability PPTC material of claim 1, wherein the conductive filler component comprises a volume percentage ranging between to 10% to 25%.

8. The high stability PPTC material of claim 1, wherein the polymer matrix comprises a semicrystalline polymer, a fluororesin, a polyester, a polyether, a polyurethane, a polyamide and copolymer thereof, or a diene elastomer and copolymer thereof.

9. The high stability PPTC material of claim 1, wherein the polymer matrix comprises polyethylene and its copolymer, ethylene-vinyl acetate, ethylene and acrylic acid copolymer, ethylene butyl acrylate copolymer, polyolefin elastomer, polyethylene oxide, polyvinyl fluoride, polydivinyl fluoride, polytetrafluoroethylene, ethylene-tetrafluoroethylene copolymer, polycaprolactone, polyethylene glycol, polytetrahydrofuran, polyurethane, a polyamide, copolymer of polyamide, a diene elastomer, a copolymer of diene elastomer, or combination thereof.

10. The high stability PPTC material of claim 1, further comprising an inorganic filler, a flame retardant agent, an antioxidant, a coupling agent, an arc suppressant, a cross-linker, or combination thereof.

11. A method of preparing a high stability polymer positive temperature coefficient (PPTC) material, comprising:
providing a polymer material for a polymer matrix;
providing a carbon black material as a conductive filler component, wherein the conductive filler component comprises a plurality of carbon black particles, wherein the plurality of carbon black particles comprises an average particle size of 50 nm or less; and
mixing the carbon black material in the polymer matrix, wherein the plurality of carbon black particles comprises a treated surface before the mixing.

12. The method of claim 11, wherein the treated surface is formed by subjecting the plurality of carbon black particles to a high-temperature oxidization treatment.

13. The method of claim 11, wherein the treated surface is formed by bonding a heterogeneous chemical species to a surface of the plurality of carbon black particles.

14. The method of claim 11, wherein the plurality of carbon black particles comprise an average particle size of between 10 nm and 50 nm.

15. The method of claim 11, wherein the conductive filler component comprises a volume percentage ranging between 4% to 30%.

16. The method of claim 11, wherein the polymer matrix comprises a semicrystalline polymer, a fluororesin, a polyester, a polyether, a polyurethane, a polyamide and copolymer thereof, or a diene elastomer and copolymer thereof.

17. A high stability, high resistance polymer positive temperature coefficient (PPTC) material, comprising:
a polymer matrix, the polymer matrix defining a PPTC body; and
a conductive filler component, disposed in the polymer matrix,
wherein the conductive filler component comprises a plurality of carbon black particles, wherein the plurality of carbon black particles comprises an average particle size of 50 nm or less, and
wherein the plurality of carbon black particles comprise a treated surface.

18. The high stability, high resistance PPTC material of claim 17, comprising a room temperature resistivity of at least 10 Ohm-cm, wherein a RT/Ri value is less than 30.

19. The high stability, high resistance PPTC material of claim 17, wherein the treated surface comprises a grafted surface that comprises a heterogeneous chemical species, bonded to an inner portion of a carbon black particle.

20. The high stability, high resistance PPTC material of claim 17, wherein the treated surface comprises a high-temperature oxidized surface.
